(19) United States
(12) Patent Application Publication
(10) Pub. No.: US 2026/0296214 A1
(43) Pub. Date: Oct. 1, 2026

(54) METHOD FOR OPERATING AN ELECTRIC VEHICLE WITH A DEVICE FOR GENERATING A VIRTUAL SHIFTING SENSATION AS WELL AS AN ELECTRIC VEHICLE

(71) Applicant: Dr. Ing. h.c. F. Porsche Aktiengesellschaft, Stuttgart (DE)

(72) Inventors: Markus LINDERMEIER, Vaihingen an der Enz (DE); Jan-Peter HOFFMEISTER, Leonberg (DE); Benno WIESNER, Fellbach (DE)

(21) Appl. No.: 19/577,430

(22) Filed: Mar. 25, 2026

(30) Foreign Application Priority Data
Apr. 1, 2025 (DE) 10 2025 112 734.4

(51) Int. Cl. B60L 15/20

(52) U.S. Cl. CPC B60L 15/20; B60L 2240/12; B60L 2250/26; B60L 2260/20

(57) ABSTRACT

A method operates an electric vehicle. The electric vehicle includes a device for generating a virtual shifting sensation and a drive unit having at least one electric motor. The method includes preventing, based on a driver-side reduction of an accelerator pedal position, virtual upshifts of the device for generating the virtual shifting sensation.

### CROSS REFERENCE TO RELATED APPLICATIONS

This application claims benefit to German Patent Application No. DE 10 2025 112 734.4, filed on Apr. 1, 2025, which is hereby incorporated by reference herein.

### FIELD

The invention relates to a method for operating an electric vehicle with a device for generating a virtual shifting sensation. Furthermore, the invention relates to an electric vehicle with a device for generating a virtual shifting sensation.

### BACKGROUND

Electric vehicles are also referred to as battery electric vehicles. The drive unit of an electric vehicle has at least one electric motor, but no combustion engine. In a motor vehicle whose drive unit has a combustion engine, a multi-speed manual gearbox is connected between the internal combustion engine and an output of the motor vehicle, which for reasons of efficiency is increasingly designed as an automatic gearbox. In an automatic gearbox, gear changes are performed automatically based on a driver-side actuation of the accelerator pedal and/or brake pedal. Furthermore, automatic gearboxes are known in which gear changes are also performed manually based on a driver-side actuation of a sequential shift element, such as a shift paddle.

In an electric vehicle, there is no multi-speed manual gearbox between the electric motor and the output; at most, there is a reduction gearbox with typically a single, fixed transmission ratio or a maximum of two transmission ratios. Gear changes, as known from motor vehicles with combustion engines and multi-speed manual gearboxes, are not performed in electric vehicles. Therefore, drivers who switch from a combustion engine vehicle to an electric vehicle typically find the driving experience in an electric vehicle to be less emotionally engaging.

As explained above, the drive unit of a motor vehicle designed as an electric vehicle has at least one electric motor but no combustion engine. The electric vehicle has a traction battery in which electrical energy is stored for operating at least one electric motor. In a range extender electric vehicle, the same may be available via an internal combustion engine for charging the traction battery, but the internal combustion engine is not part of the drive unit in a range extender electric vehicle, since even in a range extender electric vehicle, only the at least one electric motor at the drive output of the electric vehicle provides drive power, but not the combustion engine. The same applies to a fuel cell electric vehicle, in which the fuel cell is used to charge the traction battery.

US 2021/0 309 113 A1 discloses an electric vehicle with a device for generating a virtual shifting sensation.

DE 10 2022 211 435 A1 discloses another electric vehicle with a device for generating a virtual shifting sensation.

### SUMMARY

In an embodiment, the present disclosure provides a method for operating an electric vehicle. The electric vehicle includes a device for generating a virtual shifting sensation and a drive unit having at least one electric motor. The method includes preventing, based on a driver-side reduction of an accelerator pedal position, virtual upshifts of the device for generating the virtual shifting sensation.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an electric vehicle according to an embodiment of the present disclosure; and

FIG. 2 shows a block diagram of assemblies of the electric vehicle according to an embodiment of the present disclosure.

### DETAILED DESCRIPTION

The present inventors have found that is a need to further enhance the driving experience in an electric vehicle. Aspects of the present disclosure provide a method for operating an electric vehicle as well as an electric vehicle.

According to an embodiment of the present disclosure, virtual upshifts of the device for generating the virtual shifting sensation are prevented based on a driver-side reduction of an accelerator pedal position.

With the embodiments of the present disclosure presented here, the driving experience can be further enhanced in an electric vehicle having a device for generating a virtual shifting sensation. In particular embodiments, a dynamic, fast-responding driving experience can be provided for the driver of the electric vehicle such that, based on the driver-side reduction of the accelerator pedal position, upshifts are prevented in order to a provide dynamic vehicle response upon subsequent greater actuation of the accelerator pedal.

In a preferred embodiment, virtual upshifts of the device for generating the virtual shifting sensation are prevented when an amount of the driver-side reduction of the accelerator pedal position and/or an amount of a temporal gradient of the driver-side reduction of the accelerator pedal position is greater than a respective limit value, in particular when furthermore an automatic operating mode of the device for generating the virtual shifting sensation is active and/or when a forward driving stage is active as the drive stage. This is advantageous for increasing the driving experience in an electric vehicle having a device for generating a virtual shifting sensation.

In a preferred embodiment, virtual upshifts of the device for generating a virtual shifting sensation are prevented based on the driver-side reduction of the accelerator pedal position, as well as based on a current driving speed of the electric vehicle and/or based on a current travel mode, in particular when the amount of the driver-side reduction of the accelerator pedal position and/or the amount of the temporal gradient of the driver-side reduction of the accelerator pedal position is greater than a respective limit value based on the current driving speed and/or current travel mode. This is again advantageous for increasing the driving experience in an electric vehicle having a device for generating a virtual shifting sensation.

In a preferred embodiment, when the amount of the driver-side reduction of the accelerator pedal position and/or the amount of the temporal gradient of the driver-side reduction of the accelerator pedal position is greater than the respective limit value and when furthermore a virtual engine speed exceeds a maximum speed, the respective virtual upshift of the device for generating the virtual shifting sensation is not prevented but rather performed. If, as a result of a suppression of an upshift, the virtual engine speed exceeds the maximum speed, which is based in particular on the current virtual gear, an upshift is performed.

In a preferred embodiment, when the amount of the driver-side reduction of the accelerator pedal position and/or the amount of the temporal gradient of the driver-side reduction of the accelerator pedal position is greater than the respective limit value and when furthermore a virtual engine speed falls below a minimum speed, virtual downshifts of the device for generating the virtual shifting sensation are performed. If the virtual engine speed falls below a minimum speed for the respective current virtual gear, a virtual downshift is performed.

Example embodiments of the invention will be explained in greater detail with reference to the drawings, but without being restricted thereto.

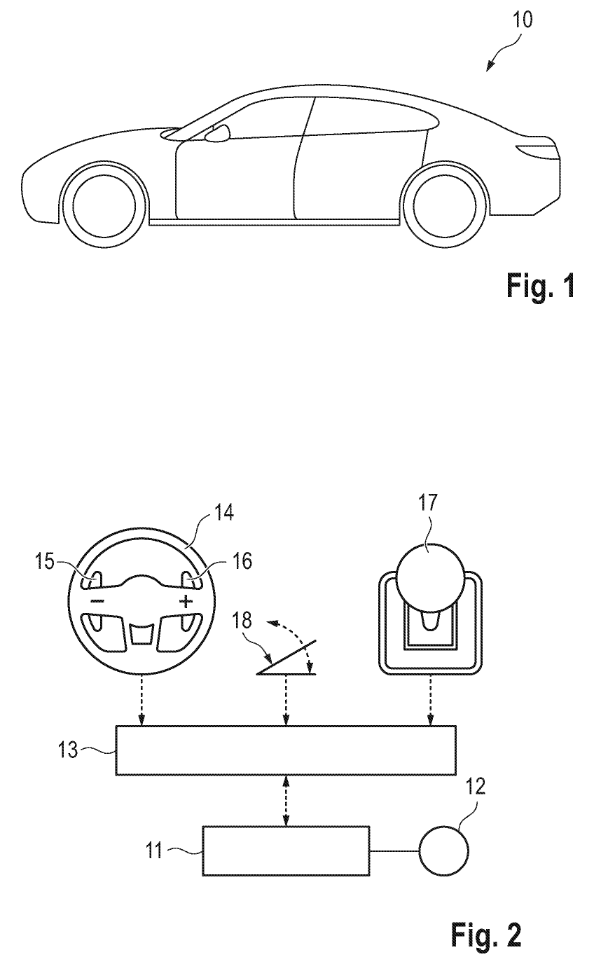

FIG. 1 shows a motor vehicle configured as an electric vehicle 10. In an electric vehicle 10, a drive unit thereof has at least one electric motor 11, but no internal combustion engine.

It is possible that the drive unit of the electric vehicle 10 has a single electric motor 11, which then drives an axle of the electric vehicle 10. The drive unit of the electric vehicle 10 may also comprise several electric motors 11. For example, with two driven axles of the electric vehicle 10, each of the driven axles may be assigned an individual electric motor 11, wherein the electric vehicle 10 then has two electric motors 11.

Each driven wheel of the electric vehicle 10 can also be assigned an individual electric motor 11, wherein the number of electric motors 11 of the drive unit of the electric vehicle 10 corresponds to the number of driven wheels of the electric vehicle 10.

The number of electric motors 11 in the drive unit of the electric vehicle 10 is purely illustrative.

FIG. 2 shows highly schematized assemblies of an electric vehicle 10, namely an electric motor 11, which provides drive power to a drive output 12 of the electric vehicle 10.

In an electric vehicle 10, unlike combustion engine-powered motor vehicles, there is no multi-speed manual gearbox between the electric motor 11 and the drive output 12, but at most a reduction gearbox with a single, fixed transmission ratio or two transmission ratios. Accordingly, in electric vehicles 10, gear changes are not performed based on driver-side actuation of the accelerator pedal and/or based on driver-side actuation of a brake pedal of the electric vehicle 10 in a multi-gear transmission, as is known from internal combustion engines. This restricts the driving experience of an electric vehicle 10.

In order to enhance the driving experience of an electric vehicle 10, an electric vehicle 10 according to an embodiment of the invention comprises a device 13 for generating a virtual shifting sensation. The device 13 for generating a virtual shifting sensation can simulate a virtual gearbox with virtual shifts by means of the device 13 for generating the virtual shifting sensation controlling the at least one electric motor 11 of the electric vehicle 10 in such a way that the at least one electric motor 11 provides a torque profile at the output 12 that corresponds to a torque profile that would be formed when gear changes are performed in combustion engine-powered motor vehicles with a multi-speed manual gearbox.

When the device 13 for generating the virtual shifting sensation is deactivated, the electric vehicle 10 is operated like a conventional electric vehicle without performing virtual shifting. If, on the other hand, the device 13 for generating the virtual shifting sensation is activated, it generates a virtual shifting sensation for a driver. In so doing, the device 13 for generating the virtual shifting sensation can, in preferred embodiments, generate either a virtual automatic switching sensation in a first, automatic operating mode, or a virtual manual shifting sensation in a second, manual operating mode.

In the first automatic operating mode, the device 13 simulates the presence of an automatic, multi-speed manual gearbox such that the device 13 for generating a virtual shifting sensation depending on the driver’s actuation of an accelerator pedal 18 and/or depending on the driver's actuation of a brake pedal (not shown) performs virtual automatic shifting, and by controlling the electric machine 11 at the drive output 12, it provides a torque curve that would be formed at the output 12 if an automatic multi-speed manual gearbox were present. The accelerator pedal 18 is also referred to as the gas pedal.

A driver request is based on driver-side actuation of the accelerator pedal 18 as well as the brake pedal.

The torque curve to be provided at the drive output 12 in the first, automatic operating mode can, in particular embodiments, be determined by the device 13 for generating the virtual shifting sensation based on the actuation of the accelerator pedal 18 and/or based on the actuation of the brake pedal in a map-based manner, in particular embodiments also based on a virtual current gear and virtual target gear of the respective virtual shift to be performed.

On the other hand, when the second, manual operating mode of the device 13 for generating the virtual shifting sensation is activated, the device 13 generates a virtual manual shifting sensation, in particular embodiments depending on the driver’s actuation of sequential shift elements 15, 16 installed on a steering wheel 14 of the electric vehicle, which can be embodied as shift paddles in the example embodiment shown. If the second, manual operating mode of the device 13 for generating the virtual shifting sensation is active, the device 13 for generating the virtual shifting sensation depending on the driver’s actuation of the sequential shift element 15, 16 controls the electric motor 11 in such a way that it performs the same virtual sequential shifts and provides a torque curve at the drive output 12 that would develop if a multi-speed manual gearbox operated in sequential shift mode or operating mode were present in the electric vehicle 10.

The torque curve to be provided at the drive output 12 in the second, manual operating mode can be determined in particular embodiments by the device 13 for generating the virtual shifting sensation depending on the actuation of the respective sequential shift element 15, 16 in a mapped-based manner.

The device 13 for generating the virtual shifting sensation of the electric vehicle 10 accordingly simulates the presence of a multi-speed manual gearbox based on the operating mode of the same.

When the device 13 for generating the virtual shifting sensation of the electric vehicle 10 is activated, it can, in preferred embodiments, be operated in two operating modes, namely, as described above, in the first automatic operating mode or in the second manual operating mode.

Accordingly, when the device 13 for generating the virtual shifting sensation is deactivated, the motor vehicle behaves like a conventional electric vehicle, and no virtual shifts are simulated, and no virtual shifting sensation is provided. If, on the other hand, the device 13 for generating the virtual shifting sensation is activated, it provides a virtual shifting sensation depending on the activated operating mode by executing virtual shifts, simulating a virtual gearbox, in particular embodiments by the device 13 for generating the virtual shifting sensation controlling the electric motor 11 in such a way that it provides a torque curve at the output 12 as would be formed when a gear change is performed in a multi-speed manual gearbox of a combustion engine vehicle.

The device 13 for generating the virtual shifting sensation simulates not only a virtual gearbox but also a virtual internal combustion engine, based on whose virtual engine speed and/or virtual torque virtual shifts are performed, in particular embodiments in the first, automatic operating shift mode.

If, in the first, automatic operating mode, based on a driver-side actuation of the accelerator pedal 18 and/or based on a driver-side actuation of the brake pedal, virtual shift points based on the virtual engine speed of the virtual internal combustion engine and/or on the virtual torque of the virtual internal combustion engine are reached, virtual shifts can be performed. This is done in particular embodiments in a map-based manner via virtual shift maps of a virtual shift strategy.

The virtual engine speed of the virtual internal combustion engine can be simulated by the device 13 for generating the virtual shifting sensation in that, depending on a driving speed or rotational speed known on the control side at the drive output 12 of the electric vehicle 10 or the rotational speed of the electric motor 11 and the virtual transmission of a virtual gear that has been engaged, the virtual engine speed of the virtual internal combustion engine is calculated.

Depending on the virtual engine speed of the virtual internal combustion engine calculated in this way, the device 13 for generating the virtual shifting sensation can determine a virtual torque of the virtual internal combustion engine in a map-based or characteristic curve-dependent manner, namely based on a virtual engine map of the virtual internal combustion engine.

FIG. 2 further illustrates a travel direction selection lever 17 of the electric vehicle 10. With the travel direction selection lever 17, a drive stage can be selected on the driver side, such as a forward drive stage D or a reverse drive stage R or neutral N.

As discussed above, in the automatic operating mode of the device 13 for generating a virtual shifting sensation, virtual shifts are performed automatically based on the driver-side actuation of the accelerator pedal 18 and the driver-side actuation of the brake pedal. In embodiments, based on a driver-side reduction of the accelerator pedal position of the accelerator pedal 18, virtual upshifts of the device 13 for generating the virtual shifting sensation are prevented, i.e. such virtual upshifts are not performed, in particular embodiments when an amount of the driver-side reduction of the accelerator pedal position and/or an amount of a temporal gradient of the driver-side reduction of the accelerator pedal position is greater than a respective limit value.

Virtual upshifts of the device 13 for generating the virtual shifting sensation are prevented based on the driver-side reduction of the accelerator pedal position of the accelerator pedal 18, as well as furthermore based on a current driving speed of the electric vehicle 10 and/or based on a current travel mode. In particular embodiments, it is provided that the limit value for the amount of the driver-side reduction of the accelerator pedal position and/or the limit value for the amount of the temporal gradient of the driver-side reduction of the accelerator pedal position, based on which the virtual upshifts of the device 13 for generating the virtual shifting sensation are prevented, is determined based on the current driving speed and/or based on the current travel mode, in particular in a map-based manner.

For example, different limit values can be maintained at the same driving speed for an eco travel mode of the electric vehicle 10 or range travel mode of the electric vehicle 10 or sport travel mode of the electric vehicle 10 or performance travel mode of the electric vehicle 10 or race travel mode of the electric vehicle 10, as a function of which the virtual upshifts of the device 13 for generating the virtual shifting sensation are prevented upon driver-side reduction of the position of the accelerator pedal 18. Likewise, for each of these travel modes of the electric vehicle 10, the respective limit value can be changed, in particular embodiments in a driving speed-based manner via a respective map, in order to provide different limit values at different driving speeds, as a function of which virtual upshifts are then prevented based on the driver-side reduction of the accelerator pedal position.

This prevention of virtual upshifts of the device 13 for generating the virtual shifting sensation based on the driver-side reduction of the accelerator pedal position occurs when the device 13 for generating a virtual shifting sensation is operated in the automatic shift mode and when the forward drive stage D is still active as the drive stage.

By preventing virtual upshifts of the device 13 for generating the virtual shifting sensation based on the driver-side reduction of the accelerator pedal position, a time delay can be reduced in the transition between deceleration phases and acceleration phases of the electric vehicle 10 in order to provide a particularly dynamic or athletic driving experience in an electric vehicle 10.

In particular embodiments, the amount of the reduction of the accelerator pedal position and additionally the temporal gradient of the reduction of the accelerator pedal position is evaluated. If the temporal gradient of the accelerator pedal position of a driver-side reduction of the accelerator pedal position is large in terms of its sum, the accelerator pedal position changes rapidly. For the amount of the temporal gradient of the driver-side reduction of the accelerator pedal position, a respective limit value is preferably stored, upon achieving which virtual upshifts of the device 13 for generating the virtual shifting sensation are prevented. Accordingly, when preventing virtual upshifts of the device 13 for generating the virtual shifting sensation, both the amount of the change in the accelerator pedal position and the amount of the temporal gradient of the change in the accelerator pedal position are preferably taken into account.

When, during a suppression of the upshift based on driver-side reduction of the accelerator pedal position, a virtual engine speed exceeds a maximum speed, which is in particular embodiments based on the current virtual gear of the device 13 for generating the virtual shifting sensation, the virtual upshift is not prevented by the device 13 for generating the virtual shifting sensation, but rather performed. If, during the prevention of an upshift as a result of the driver-side reduction of the accelerator pedal position, the virtual engine speed exceeds a minimum speed, then a virtual downshift is performed by the device 13 for generating the virtual shifting sensation.

Based on the suppression of a virtual upshift of the device 13 for generating the virtual shifting sensation, a torque control for the electric motor 11 can also be adapted in order to ensure immediate responsiveness when actuating the accelerator pedal 18. This is done taking into account and ensuring the travel control or driving stability.

In a further embodiment, it is provided that the driver is given optical and/or audible feedback regarding the suppression of virtual upshifts. For example, corresponding feedback can be displayed in an instrument cluster of the electric vehicle or in a central display of the electric vehicle.

In an embodiment, the suppression of the virtual upshifts in the device 13 for generating the virtual shifting sensation based on the driver-side reduction of the accelerator pedal position occurs only when the forward drive stage D is active as the drive stage. If forward drive stage D is no longer active, the suppression of the virtual upshifts is stopped based on the driver-side reduction of the accelerator pedal position.

Even when the amount of the driver-side reduction of the accelerator pedal position and/or the amount of a temporal gradient of the driver-side reduction is no longer greater than the respective limit value, the suppression of upshifts is stopped.

Furthermore, when the prevention of virtual upshifts is started due to the amount of the driver-side reduction of the accelerator pedal position and/or the amount of a temporal gradient of the driver-side reduction accelerator pedal position becoming greater than the respective limit value, a timer can be started, upon the expiry of which virtual upshifts are stopped.

As already discussed above, the prevention of virtual upshifts can be stopped based on the virtual engine speed. If the virtual engine speed is greater than a maximum speed, which is based in particular on the current virtual gear of the device 13 for generating the virtual shifting sensation, the prevention of upshifts is stopped and a virtual upshift is performed so that the virtual engine speed can be reduced.

Embodiments of the invention relate to the electric vehicle having a drive unit with at least one electric motor 11 and with the device 13 for generating a virtual shifting sensation. The device 13 of the electric vehicle 10 is configured so as to prevent virtual upshifts in the manner described above based on driver-side reduction of an accelerator pedal position. With embodiments, in case of rapid reductions in the accelerator pedal position, an athletic driving behavior can be provided, in particular embodiments in order to enable a subsequent acceleration procedure when transitioning into a subsequent acceleration phase with high dynamics.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for operating an electric vehicle, the electric vehicle comprising a device for generating a virtual shifting sensation and a drive unit having at least one electric motor, the method comprising:
preventing, based on a driver-side reduction of an accelerator pedal position, virtual upshifts of the device for generating the virtual shifting sensation.

2. The method according to claim 1, wherein the virtual upshifts of the device for generating the virtual shifting sensation are prevented when an amount of the driver-side reduction of the accelerator pedal position or an amount of a temporal gradient of the driver-side reduction of the accelerator pedal position is greater than a respective limit value.

3. The method according to claim 1, wherein the virtual upshifts of the device for generating the virtual shifting sensation are prevented based on the driver-side reduction of the accelerator pedal position as well as based on a current driving speed of the electric vehicle or based on a current travel mode.

4. The method according to claim 3, wherein the virtual upshifts of the device for generating the virtual shifting sensation are prevented when an amount of the driver-side reduction of the accelerator pedal position or an amount of a temporal gradient of the driver-side reduction of the accelerator pedal position is greater than a respective limit value based on the current driving speed or the current travel mode.

5. The method according to claim 1, further comprising:
performing the virtual upshifts of the device for generating the virtual shifting sensation when an amount of the driver-side reduction of the accelerator pedal position or an amount of a temporal gradient of the driver-side reduction of the accelerator pedal position is greater than a respective limit value and when a virtual engine speed exceeds a maximum speed.

6. The method according to claim 1, further comprising:
performing virtual downshifts of the device for generating the virtual shifting sensation when an amount of the driver-side reduction of the accelerator pedal position or an amount of a temporal gradient of the driver-side reduction of the accelerator pedal position is greater than a respective limit value, and when a virtual engine speed falls below a minimum speed.

7. The method according to claim 1, further comprising:
generating a virtual automatic shifting sensation when an automatic operating mode of the device for generating the virtual shifting sensation is activated; and
generating a virtual manual shifting sensation when a manual operating mode of the device for generating the virtual shifting sensation is activated.

8. The method according to claim 7, wherein when an amount of the driver-side reduction of the accelerator pedal position or an amount of a temporal gradient of the driver-side reduction of the accelerator pedal position is greater than a respective limit value, virtual upshifts of the device for generating the virtual shifting sensation are only prevented when the automatic operating mode is activated.

9. The method according to claim 1, wherein, when an amount of the driver-side reduction of the accelerator pedal position or an amount of a temporal gradient of the driver-side reduction of the accelerator pedal position is greater than a respective limit value, virtual upshifts of the device for generating the virtual shifting sensation are only prevented when a forward drive stage is active as a drive stage.

10. An electric vehicle, comprising:
a drive unit comprising at least one electric motor; and
a device for generating a virtual shifting sensation,
wherein the device for generating the virtual shifting sensation is configured to prevent virtual upshifts based on a driver-side reduction of an accelerator pedal position.
